(19) United States
(12) Patent Application Publication
(10) Pub. No.: US 2009/0313991 A1
(43) Pub. Date: Dec. 24, 2009

(54) Turbocharger cleaning

(76) Inventors: Brian Carl Kuznicki, Columbus, IN (US); Rickey Albert MacKey, Edinburgh, IN (US); Timothy James William Proctor, Columbus, IN (US); Gregory Scott Franks, Edinburgh, IN (US)

Correspondence Address: KRIEG DEVAULT LLP, ONE INDIANA SQUARE, SUITE 2800, INDIANAPOLIS, IN, 46204-2079, US

(21) Appl. No.: 12/386,502

(22) Filed: Apr. 17, 2009

Related U.S. Application Data
(60) Provisional application No. 61/124,555, filed on Apr. 17, 2008.

(51) Int. Cl. F02B 33/34; F04D 29/46; F04D 29/00; B08B 7/00; B23P 15/04

(52) U.S. Cl. 60/605.1; 415/160; 415/117; 134/20; 29/889.2

(57) ABSTRACT

A turbocharger having a cleaning port communicating between an external surface of the turbocharger housing and an internal cavity which communicates with a component of a gas flow control mechanism.

### CROSS REFERENCE TO RELATED APPLICATIONS

The present application claims the benefit of U.S. Patent Application No. 61/124,555, filed Apr. 17, 2008, which is incorporated herein by reference.

The present invention relates to turbochargers. In particular the present invention relates to variable geometry turbochargers.

Turbochargers are well known devices for supplying air to the intake of an internal combustion engine at pressures above atmospheric pressure (boost pressures). A conventional turbocharger essentially comprises an exhaust gas driven turbine wheel mounted on a rotatable shaft within a turbine housing connected downstream of an engine outlet manifold. Rotation of the turbine wheel rotates a compressor wheel mounted on the other end of the shaft within a compressor housing. The compressor wheel delivers compressed air to the engine intake manifold. The turbocharger shaft is conventionally supported by journal and thrust bearings, including appropriate lubricating systems, located within a central bearing housing connected between the turbine and compressor wheel housings.

In known turbochargers, the turbine stage comprises a turbine chamber within which the turbine wheel is mounted; an annular inlet passageway defined between facing radial walls arranged around the turbine chamber; an inlet arranged around the inlet passageway; and an outlet passageway extending from the turbine chamber. The passageways and chambers communicate such that pressurised exhaust gas admitted to the inlet chamber flows through the inlet passageway to the outlet passageway via the turbine and rotates the turbine wheel. It is also known to improve turbine performance by providing vanes, referred to as nozzle vanes, in the inlet passageway so as to deflect gas flowing through the inlet passageway towards the direction of rotation of the turbine wheel.

Turbines may be of a fixed or variable geometry type. Variable geometry turbines differ from fixed geometry turbines in that they comprise a variable geometry inlet mechanism that is operated to vary the size of the inlet passageway to optimise gas flow velocities over a range of mass flow rates so that the power output of the turbine can be varied to suite varying engine demands. For instance, when the volume of exhaust gas being delivered to the turbine is relatively low, the velocity of the gas reaching the turbine wheel is maintained at a level that ensures efficient turbine operation by reducing the size of the annular inlet passageway. Turbochargers provided with a variable geometry turbines are referred to as variable geometry turbochargers.

In one known type of variable geometry turbocharger, the variable geometry inlet mechanism comprises an axially moveable wall member, generally referred to as a “nozzle ring”, which defines one wall of the turbine inlet passageway. The nozzle ring is supported on rods extending parallel to the turbine axis, and is moved by an actuator linked to the rods. The position of the nozzle ring relative to a facing wall of the inlet passageway is adjustable to control the axial width of the inlet passageway. Thus, for example, as gas flow through the turbine decreases, the inlet passageway width may be decreased to maintain gas velocity and optimise turbine output. The nozzle ring is provided with vanes which extend into the inlet and through slots provided in a “shroud” defining the facing wall of the inlet passageway to accommodate movement of the nozzle ring.

In another known type of variable geometry turbocharger, sometimes referred to as a “swing vane” type, the variable geometry inlet mechanism comprises a variable guide vane array comprising adjustable guide vanes arranged to pivot about respective axles extending across the turbine inlet, so as to open and close the inlet passageway. The vanes are pivoted in unison by an actuating mechanism including an actuating ring sometimes referred to as a “unison ring”. The unison ring is linked to the vane axles so that rotation of the unison ring about the turbine axis pivots each of the vanes about its respective axle.

It is known that soot present in engine exhaust gas can accumulate on components of the turbine. It has now been found that soot accumulating on the components of a variable geometry inlet mechanism can interfere with operation of the mechanism. For instance increasing friction between moving parts of the mechanism, so that some components can even become stuck, can restrict movement of the mechanism and prevent accurate control of the turbine inlet size. To return the turbine to optimum operating condition it is necessary to remove the turbocharger and dismantle the turbine for cleaning. Alternatively the turbine (or more usually turbocharger) may simply be removed and replaced. This problem can be exacerbated on some modern engines in which exhaust gas may be relatively rich in unburned hydrocarbons to support regeneration reactions in a downstream exhaust after treatment system.

The present invention addresses the above problems.

According to a first aspect of the present invention there is provided a turbocharger comprising a turbine wheel mounted within a housing for rotation about a turbine axis, a gas flow inlet passage upstream of the turbine wheel, and a gas flow control mechanism located within said housing upstream of said turbine wheel and operable to control gas flow through said gas flow inlet passage, wherein a cleaning port is provided in a wall of the housing, the cleaning port communicating between an external surface of the housing and an internal cavity which communicates with at least one component of the gas flow control mechanism.

The cleaning port may be sealed by a removable plug.

The cavity may be annular.

The cavity may communicate with or comprise the inlet passage.

The gas flow control mechanism may comprise a variable geometry mechanism for varying the size of the inlet passage. For instance the inlet passage may be annular and surround the turbine wheel, and said variable geometry mechanism may include an annular wall member which is displaceable to vary the width of the annual inlet passage between a first surface defined by the annular wall member and a second surface defined by the housing, wherein the moveable wall member is mounted within said internal cavity. The annular wall member may be displaceable in a direction parallel to the turbine axis. The moveable wall member may be mounted on at least one axially displaceable rod at least a portion of which extends into said cavity.

In another embodiment the inlet passage is an annular passage defined between facing walls of the housing and surrounding the turbine wheel and said variable geometry mechanism includes an annular array of swing vanes mounted within the inlet passage, each vane being mounted for pivoting motion about a respective pivot axis extending across the inlet passage to adjust the effective area of the annular inlet passage. The annular actuating member may be linked to each of the vanes such that rotation of the actuating member about the turbine axis causes pivotal movement of each of the vanes, wherein said annular actuating member is located within said cavity.

In some embodiments the cleaning port extends at an angle α defined between the turbine axis and an orthogonal projection of the cleaning port onto a first reference plane containing the turbine axis and passing through the cleaning port, wherein the angle α is between 0° and 90°. The angle α may for instance be between 30° and 60°. In one embodiment the angle α is about 45°.

The cleaning port may extend at an angle β defined between the turbine axis and an orthogonal projection of the port onto a second reference plane containing the turbine axis and extending perpendicular to the first reference plane, wherein the angle β is between 0° and 90°. The angle β may for instance be between 15° and 60°. In one embodiment the angle β is about 30°.

According to a second aspect of the present invention there is provided a method of cleaning the gas flow control mechanism of a turbocharger according to the first aspect of the invention, the method comprising dispensing a volume of cleaning fluid into the cavity via said cleaning port. The turbocharger may be in situ connected to an internal combustion engine. The engine may be run to raise the temperature of the engine and turbocharger to an elevated temperature to enhance operation of the cleaning fluid.

The cleaning method may for instance comprise the steps of:
a. running the engine to raise the temperature of the engine and turbocharger to a normal operating temperature;
b. dispensing cleaning fluid into said cavity when the engine has reached said normal operating temperature;
c. actuating the gas flow control mechanism with the cleaning fluid present in said cavity.

According to a third aspect of the present invention there is provided a method of machining a cleaning port through a wall of a housing of a turbocharger to produce a turbocharger according to the first aspect of the invention the method comprising:
securing a jig to the turbine housing, the jig being adapted for precise location in a predetermined position and orientation on the turbine housing, the jig including a guide bore;
drilling a hole through the housing wall to form said cleaning port by insertion of a drill bit through the guide bore and into contact with the housing wall.

The method may further comprise removing the drill bit from said guide bore and inserting a tap through said guide bore and into the cleaning bore to machine a thread on the inner surface of the cleaning bore.

The guide bore may be adapted to alternately receive and support a drill guide bush adapted for receiving and guiding said drill, and a tap guide bush adapted for receiving and guiding said tap.

According to a fourth aspect of the present invention there is provided a jig for use in machining a cleaning port in accordance with the method of the third aspect of the present invention, the jig comprising a base supporting a formation defining said guide bore, the base being configured for securing to the turbocharger housing in a particular predetermined position.

According to a fifth aspect of the present invention there is provided a method of servicing a turbocharger, the turbocharger comprising a turbine wheel mounted within a housing for rotation about a turbine axis, a gas flow inlet passage upstream of said turbine wheel, and a gas flow control mechanism located within said housing upstream of said turbine wheel and operable to control gas flow through said gas flow inlet passage, the method comprising
machining a cleaning port according to the method of the second aspect of the invention; and
performing a cleaning operation according to the method of the third aspect of the present invention.

Specific embodiments of the present invention will now be described, by way of example only, with reference to the accompany drawings, in which:

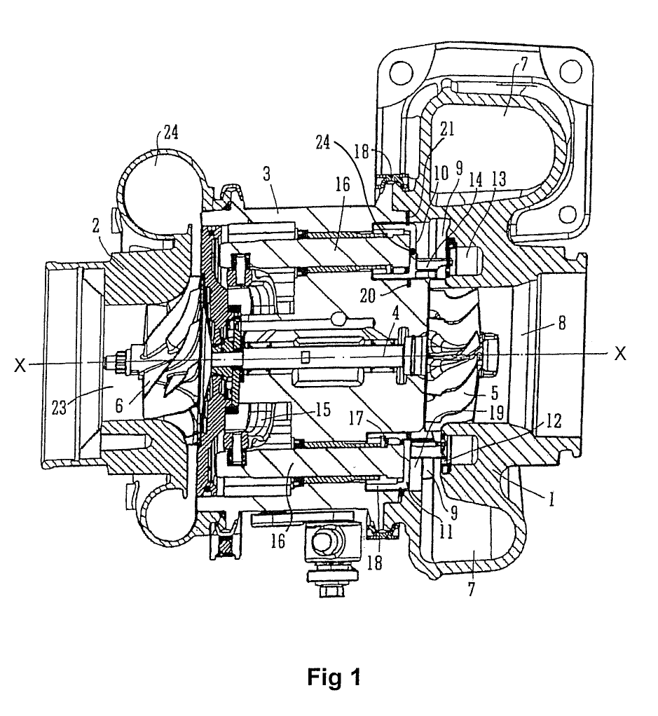

FIG. 1 is an axial cross-section through a known variable geometry turbocharger;

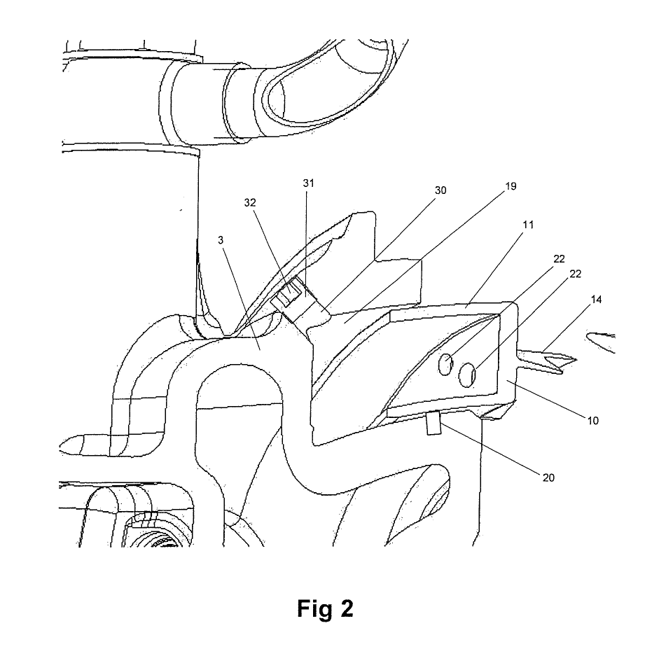

FIG. 2 is an axial cross-section through a part of the housing of a turbocharger according to the present invention;

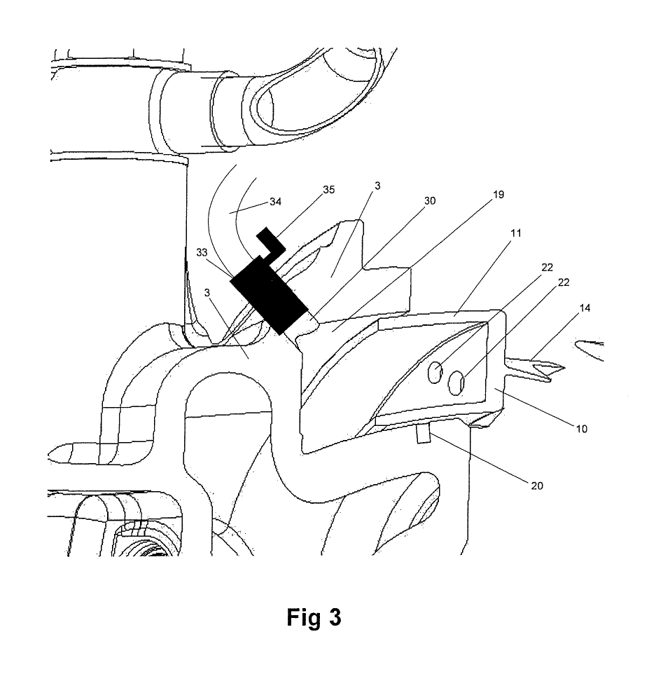

FIG. 3 illustrates a turbocharger cleaning operation according to the present invention performed on the turbocharger of FIG. 2;

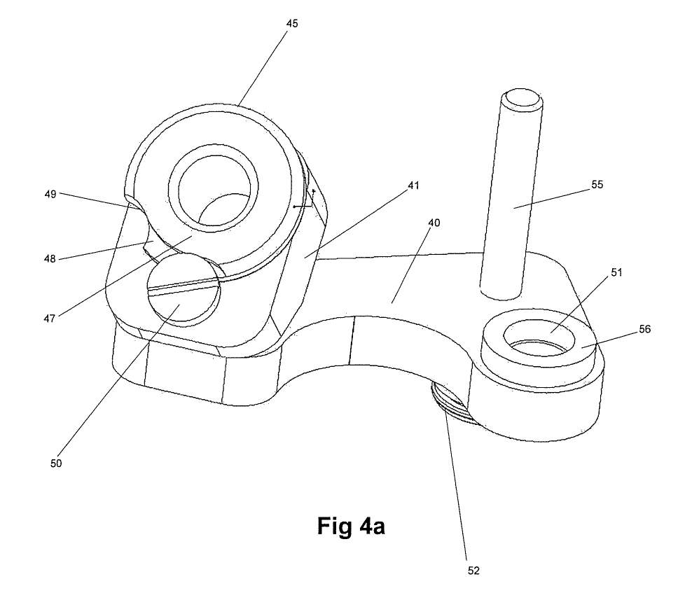

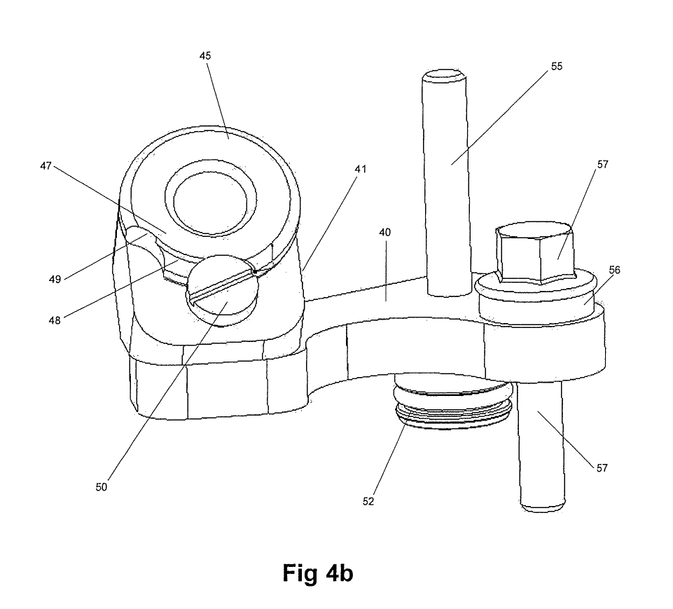

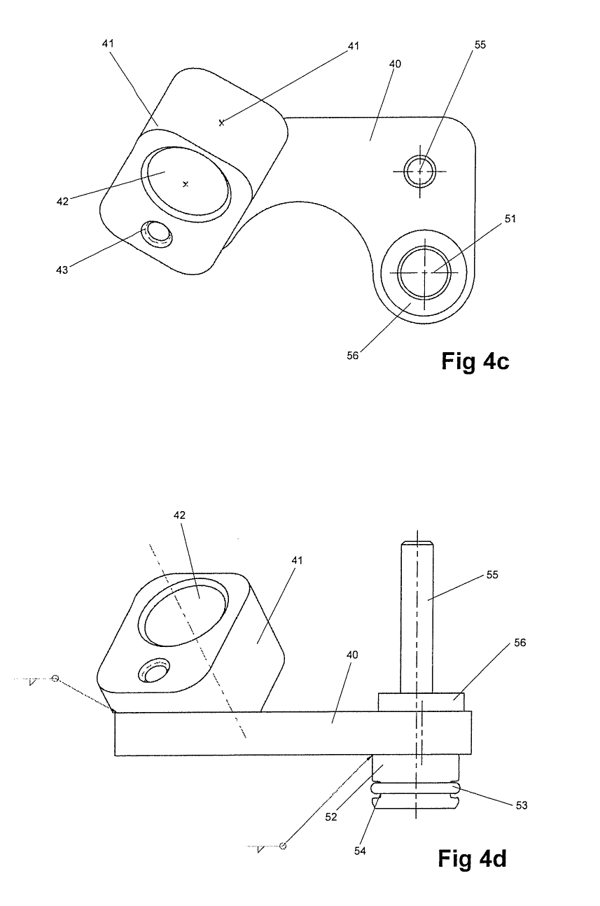

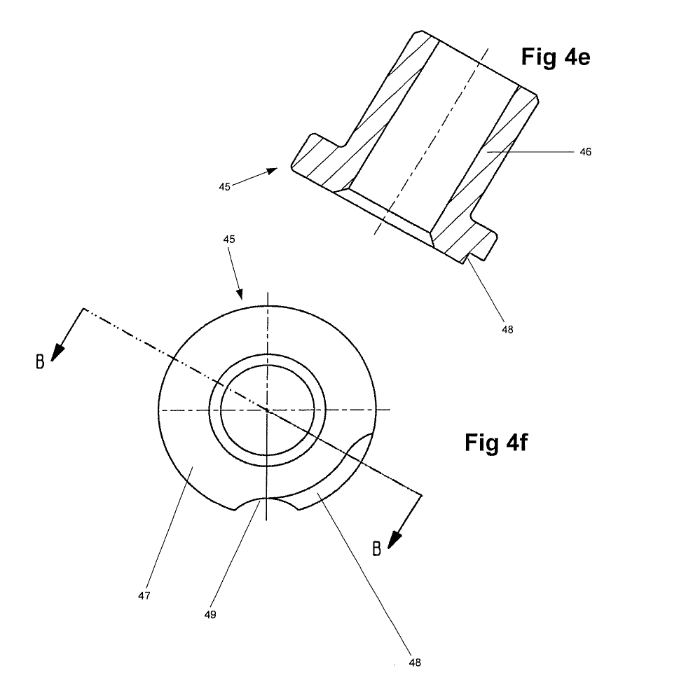

FIG. 4a to 4f illustrate a jig for use in machining a cleaning port in a turbocharger in accordance with the present invention; and

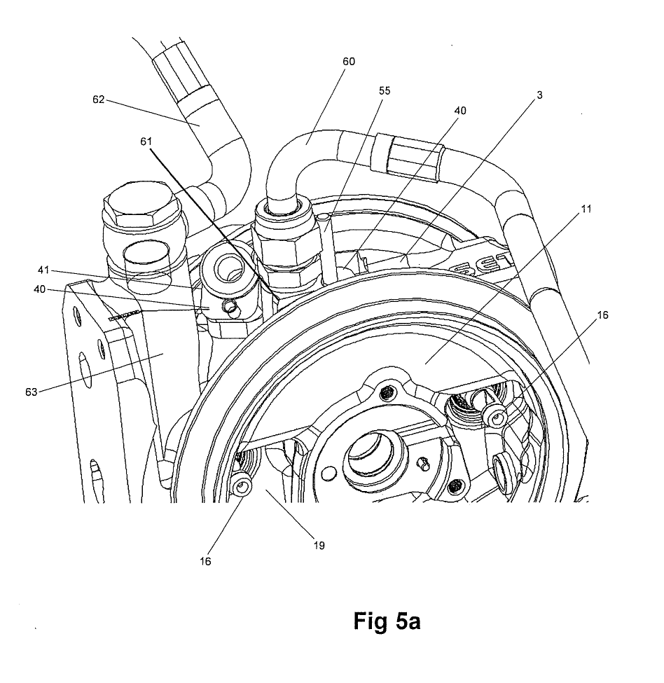

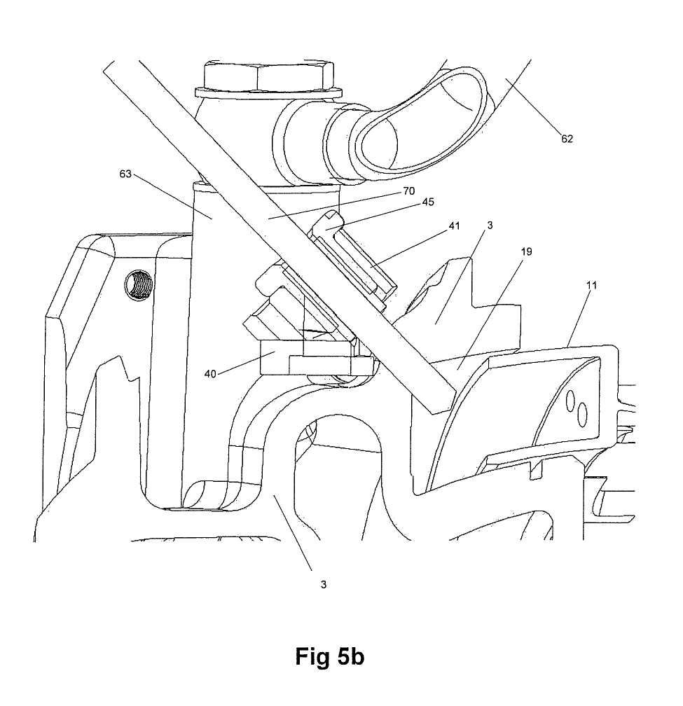

FIGS. 5a and 5b illustrates a turbocharger cleaning port machining operation according to the present invention using the jig of FIGS. 4a to 4e.

Referring to FIG. 1, this illustrates a known variable geometry turbocharger comprising a variable geometry turbine housing 1 and a compressor housing 2 interconnected by a central bearing housing 3. A turbocharger shaft 4 extends from the turbine housing 1 to the compressor housing 2 through the bearing housing 3. A turbine wheel 5 is mounted on one end of the shaft 4 for rotation within the turbine housing 1, and a compressor wheel 6 is mounted on the other end of the shaft 4 for rotation within the compressor housing 2. The shaft 4 rotates about turbocharger axis X-X on bearing assemblies located in the bearing housing 3.

The turbine housing 1 defines an inlet volute 7 to which gas from an internal combustion engine (not shown) is delivered. The exhaust gas flows from the inlet chamber 7 to an axial outlet passageway 8 via an annular inlet passageway 9 and turbine wheel 5. The inlet passageway 9 is defined on one side by the face 10 of a radial wall of a movable annular wall member 11, commonly referred to as a “nozzle ring”, and on the opposite side by an annular shroud 12 which forms the wall of the inlet passageway 9 facing the nozzle ring 11. The shroud 12 covers the opening of an annular recess 13 in the turbine housing 1.

The nozzle ring 11 supports an array of circumferentially and equally spaced inlet vanes 14 each of which extends across the inlet passageway 9. The vanes 14 are orientated to deflect gas flowing through the inlet passageway 9 towards the direction of rotation of the turbine wheel 5. When the nozzle ring 11 is proximate to the annular shroud 12, the vanes 14 project through suitably configured slots in the shroud 12, into the recess 13.

The position of the nozzle ring 11 is controlled by an actuator assembly of the type disclosed in U.S. Pat. No. 5,868,552 (which is incorporated herein by reference). An actuator (not shown) is operable to adjust the position of the nozzle ring 11 via an actuator output shaft (not shown), which is linked to a yoke 15. The yoke 15 in turn engages axially extending rods 16 that support the nozzle ring 11. Accordingly, by appropriate control of the actuator (which may for instance be pneumatic or electric), the axial position of the rods 16 and thus of the nozzle ring 11 can be controlled.

The nozzle ring 11 has axially extending radially inner and outer annular flanges 17 and 18 that extend into an annular cavity 19 provided in the turbine housing 1. Inner and outer sealing rings 20 and 21 are provided to seal the nozzle ring 11 with respect to inner and outer annular surfaces of the annular cavity 19 respectively, whilst allowing the nozzle ring 11 to slide within the annular cavity 19. The inner sealing ring 20 is supported within an annular groove formed in the radially inner annular surface of the cavity 19 and bears against the inner annular flange 17 of the nozzle ring 11. The outer sealing ring 20 is supported within an annular groove formed in the radially outer annular surface of the cavity 19 and bears against the outer annular flange 18 of the nozzle ring 11. As taught by U.S. Pat. No. 5,522,697 (which is incorporated herein by reference) an annular array of pressure balance apertures 22 is provided through the face 10 of the nozzle ring 11 to reduce the pressure difference across the nozzle ring, which reduces axial load on the nozzle ring 11 and improves positional control.

Gas flowing from the inlet chamber 7 to the outlet passageway 8 passes over the turbine wheel 5 and as a result torque is applied to the shaft 4 to drive the compressor wheel 6. Rotation of the compressor wheel 6 within the compressor housing 2 pressurises ambient air present in an air inlet 23 and delivers the pressurised air to an air outlet volute 24 from which it is fed to an internal combustion engine (not shown). The speed of the turbine wheel 5 is dependent upon the velocity of the gas passing through the annular inlet passageway 9. For a fixed rate of mass of gas flowing into the inlet passageway, the gas velocity is a function of the width of the inlet passageway 9, the width being adjustable by controlling the axial position of the nozzle ring 11. FIG. 1 shows the annular inlet passageway 9 fully open. The inlet passageway 9 may be closed to a minimum by moving the face 10 of the nozzle ring 11 towards the shroud 12.

Although the nozzle ring 11 is sealed with respect to the nozzle ring cavity 19, the provision of the pressure balance apertures 22 allows exhaust gas to flow into the cavity 19 behind the face 10 of the nozzle ring 11. The inside surfaces of the nozzle ring cavity 19 together with contact surfaces between the support rods (not shown) and the nozzle ring 11 are therefore exposed to exhaust gas and to the accumulation of soot which may then impair movement of the nozzle ring 11.

An embodiment of a first aspect of the present invention will now be described with reference to FIG. 2 which shows a section through part of a turbocharger of the general type illustrated in FIG. 1.

Detailed configuration of the components of the turbocharger of FIG. 2 are not identical to those of FIG. 1, but like reference numerals will be used to indicate corresponding components.

Referring to FIG. 2, a section through part of the bearing housing 3 is shown (with the turbine housing and various other components removed for clarity). A nozzle ring 11 supporting inlet vanes 14 is slidably mounted within a annular cavity 19, and sealed with respect thereto by annular seal member 20. Also visible in FIG. 2 are pressure balance apertures 22 provided through the face 10 of the nozzle ring 11. Details of the nozzle ring support rods and actuating mechanism are not shown in FIG. 2 but these may for instance be substantially the same as those shown in FIG. 1.

In accordance with the present invention the bearing housing 3 is provided with a cleaning port 30 which is closed by a removable plug 31. The port 30 communicates between the nozzle ring cavity 19 and the external surface of the housing 3 and is tapped to receive the plug 31 which can be tightened in the port 30 using a suitable tool inserted into hex socket 32. The plug may be provided with a tapered thread, commonly referred to as a “pipe thread”, to provide a dry seal as the plug is tightened.

In accordance with the present invention the cleaning port 30 allows cleaning fluid to be introduced behind the nozzle ring 11 where it can reach components of the nozzle ring support and actuating mechanism. This will facilitate cleaning of the variable geometry inlet mechanism without the need to dismantle the turbine. A cleaning operation may for instance be performed with the turbocharger in situ connected to an engine. An example of a cleaning operation in accordance with the present invention will now be described with reference to FIG. 3.

In accordance with the present invention, the variable geometry inlet mechanism of the turbocharger is cleaned after first removing the plug 32 from the cleaning port 32 and installing in its place the nozzle 33 of a cleaning fluid hose 34. An appropriate cleaning fluid is then delivered into the nozzle ring cavity 19 via the hose 34 and nozzle 33. Any suitable non-combustible cleaner may for instance be used and appropriate water based cleaning fluids are commercially available. One such cleaning fluid is the diesel turbocharger cleaner sold by Mopar™ which comprises four parts distilled water to one part ZOK™ (a proprietary cleaning fluid sold by ZOK International Group Ltd). Such cleaning fluids are typically available in dispensing canisters. In accordance with the present invention such a dispensing canister (not shown) may be attached to the end of the cleaning hose 34 and the cleaning fluid released into the nozzle ring cavity 19. When the cleaning operation is completed, the plug 32 is refitted to seal the cleaning port 30.

Commercially available water based cleaning fluids such as Mopar™ diesel turbocharger cleaner referred to above, may be most effective when the turbocharger is at a raised temperature, for instance of the order of a typical operating temperature e.g. around 70° C. to 90° C. or so. It is therefore preferable to run the vehicle engine until the engine and turbocharger reaches a normal operating temperature which will usually be ±5% of the engine thermostat temperature, which may typically be about 82° or so. Whether or not the engine has reached normal running temperature can be determined using the conventional temperature sensors typically fitted to the engine.

In accordance with one method of performing the cleaning operation, the engine is run prior to removing the plug 31 so that turbocharger reaches an operating temperature. Once the turbocharger has warmed up, the engine is stopped and the cleaning plug 32 is removed to allow the cleaning hose nozzle 33 to be installed. The cleaning nozzle 33 preferably includes a simple hand operated tap 35 which is maintained in a closed position at this stage. The vehicle engine is then restarted and allowed to idle until the engine/turbocharger again reaches normal operating temperature.

A canister of cleaning fluid (not shown) is then attached to the hose 34, and once the engine reaches operating temperature the nozzle tap 35 is opened and the cleaning fluid dispensed into the nozzle ring cavity 19, whilst the engine is running. This may take several minutes depending on the amount of cleaning fluid dispensed. When sufficient fluid has been dispensed into the nozzle ring cavity 19. For instance the entire contents of a 14-ounce canister may be dispensed. The cleaning hose nozzle tap 35 is then closed and the engine is turned off.

It is preferable that once the cleaning fluid has been introduced to the cavity 19 the nozzle ring 11 is moved within the nozzle ring cavity 19 to help distribute the cleaning fluid to surfaces that need to be cleaned. Accordingly, as part of a cleaning cycle an appropriate operation is performed to move the nozzle ring. For instance, in many turbocharger applications this can be achieved simply by switching the vehicle ignition from the “off position” to the “on position” without starting the engine, which causes the turbocharger nozzle ring to be moved between a rest position and an engine start up position. This operation can be cycled a number of times.

In testing, three successive cleaning cycles, with the vehicle ignition switching operation (to move the nozzle ring) performed of the order of ten times during each cleaning cycle, has proved sufficient to achieve very effective cleaning of a turbocharger with a variable geometry mechanism which has become clogged with soot.

Once the cleaning operation is complete, the cleaning fluid hose nozzle 34 is removed and the plug 31 reinstalled to seal the cleaning port 30.

It will appreciated that details of the cleaning operation may vary from one turbocharger installation to the next. For instance, it may well be advisable to remove sensors, such as oxygen sensors, from the exhaust system downstream from the turbocharger to prevent such sensors becoming contaminated with the cleaning fluid during the cleaning operation.

It will also be appreciated that the temperature at which the cleaning operation is performed may very considerably between different engine installations and may vary depending on the nature of the cleaning fluid used. For instance, some cleaning fluids may be effective over a broader temperature range. For example, if a cleaning fluid is sufficiently effective at normal room temperatures, there may be no need to warm up the engine/turbocharger.

Details of the cleaning fluid canister, and the nature of its connection to the cleaning fluid hose 34, are not shown but it will be appreciated these may vary depending on the nature of the canister or other container holding the cleaning fluid. Appropriate connections can easily be made by the skilled person. The hose 34 may of course be pre-fitted with a connection suitable for attachment to a recommended proprietary cleaning fluid canister, such as the Mopar™ diesel turbocharger cleaning fluid referred to above.

It will further be appreciated that the volume of cleaning fluid dispensed into the turbocharger during each cleaning cycle may vary depending on the size of the turbocharger, the nature of the cleaning fluid, and the level of contamination of the turbocharger. The appropriate fluid volumes and other details of a cleaning cycle, for a particular turbocharger/engine installation can readily be initially determined by trial and error and then repeated for other similar installations. For instance, a specified cleaning operation may be recommended for a particular turbocharger installation, for performance at set service intervals. This is the same approach as is commonly taken with other regular service operations determined for instance by age or mileage of a vehicle.

It is important that cleaning fluid reaches the components and surfaces prone to contamination and which can affect operation of the variable geometry mechanism when contaminated. In this regard, it has been found effective to locate the cleaning port 30 as illustrated in FIG. 1 so that it opens to the cavity 19 in the region of its radially outer corner and at an angle to the turbine axis. It has also been found effective to skew the direction of port 31 so that it has a component extending in the circumferential direction of the nozzle ring.

The cleaning port 30 thus extends in a direction which may be defined by a compound of two angles α and β where:
α is the angle defined between the turbine axis X-X and an orthogonal projection of the port on to a first reference plane containing the turbine axis X-X and passing through the out board opening of the port.

β is the angle defined between the turbine axis X-X and an orthogonal projection of the port on to a second reference plane containing the turbine axis X-X and extending perpendicularly to the first reference plane.

It will be understood that an orthogonal projection is a projection viewed in a direction normal (perpendicular) to the respective reference plane. The direction in which the port extends may be regarded as the direction of a line extending along the central axis of the port, and accordingly the angles α and β may be measured by reference to the projection of the axis of the port on to the first and second reference planes. It will be appreciated that the length of the port may vary depending for instance upon the thickness of the housing wall and that in some cases the length of the port may be less than its diameter. Such a port would still be considered to have a direction defined by a central axis.

The angles α and β may vary to accommodate different housing structures and dependent upon the nature of the variable geometry inlet mechanism, as the port is ideally positioned to ensure good cleaning fluid flow to the variable geometry mechanism. In some circumstances, the direction of the port may be influenced by restricted access to the location of the port by other features of the turbocharger. In the illustrated embodiments of the invention the angle α is about 45° and the angle β is about 30°. In other embodiments of the invention the angle α may be less than 45° or between 45° and 90°. Typically the angle α could be expected to be in the range of 30° to 60°. The angle β may be any angle between 0° and 90°, but may typically be expected to be between 15° and 60°.

The cleaning operation in accordance with the present invention can also be performed on a turbocharger not pre-fitted with a cleaning port, by first machining a cleaning port at an appropriate location on the turbocharger housing. As such, a further aspect of the present invention relates to installation of a cleaning port in a turbocharger. An appropriate location for a cleaning port can, for instance, be determined by the turbocharger manufacturer and specified to the service personnel who will perform the cleaning port installation and cleaning operation. Turbochargers include many fixed features (including connections to other engine components) which can be specified as reference points for accurate location of a cleaning port. However, in accordance with the present invention it is preferred to provide a jig which can be accurately located on the turbocharger housing to provide a precise guide for machining a cleaning port.

The skilled person will appreciate that the provision of a jig adapted for fitting to a particular piece of machinery, in this case a turbocharger housing, in a specified way to ensure consistency of location is a known concept. It will also be appreciated that differently designed turbocharger housings may require differently designed jigs. FIGS. 4a to 4f illustrate components of a jig in accordance with one embodiment of the present invention configured for use in machining a cleaning bore in a turbocharger housing as shown in FIGS. 5a and 5b.

The illustrated jig comprises a base plate 40 configured for location around features of a particular turbocharger housing (as described below in relation to FIGS. 5a and 5b). The base 40 supports a drill bit/tap guide 41 which is provided with a first relatively large diameter bore 42 and an adjacent relatively small diameter threaded bore 43. The large diameter bore 42 is designed to receive either one of two alternate guide bushes 45, one of which is illustrated in FIGS. 4d and 4e. The guide bush 45 comprises a cylindrical body 46 with an outer diameter corresponding to the diameter of the bore 42 and a radially extending end flange 46 of larger diameter. The internal bore of a first bush is diametered to receive a drill bit and the bore of a second bush is diametered to receive a tap. That is, two bushes are provided, one with a relatively small bore to receive a drill bit and another with a slightly larger bore to receive a corresponding tap. Each bush 45 defines a shoulder 48 around a portion of the circumference of its flange 47 extending from a radially inward indentation 49. These features enable the bush 45 to be secured in position within the jig guide 41 guide by a set screw 50 screwed into the threaded bore 43. The bush 45 is firmly held in place within the guide 41 by tightening the set screw head onto the shoulder 48. The notch 49 allows the bush 45 to be installed/removed in the guide 41 simply by loosening the set screw 50 without having to remove the set screw 50.

The under surface of the jig base plate 40 is provided with a cylindrical plug 52 (which may be a cast component of the plate 40 or welded to the plate). A sealing o-ring 53 is seated within a circumferential groove 54 defined in the outer surface of the plug 52. The plug 52 is dimensioned to locate within a feature of the turbocharger housing as will be described below.

A hole 51 is defined through the base 40 to receive a securing bolt 57 (shown in FIG. 4b) The hole 51 is surrounded by an annular spacing boss 56 the length of which is designed to accommodate a securing bolt normally used for securing a speed sensor as described below. A post 55 extends upwards from the base 40 above the location of the plug 52. The post 55 can be gripped by the user to assist in fitting and removing the jig.

The cleaning bore machining operation will now be described with reference to FIGS. 5a and 5b. FIG. 5a is an external perspective view of a portion of the turbocharger shown in section in FIG. 2 with the turbine housing removed and the nozzle ring 11 partially cut away to reveal ends of the guide rods 16. An oil supply line 60 is shown connected to the housing at a housing boss 61, and a water outlet hose 62 is shown connected to a housing boss 63. The particular jig illustrated in FIGS. 4a to 4e is configured to fit around the oil supply boss 61. The jig is secured to the housing using a bolt which normally secures a speed sensor (not visible in the figures) in position. That is, the speed sensor securing bolt (not shown) is first removed from its bolt hole and the speed sensor then removed from its hole. The jig plug 52 is then pushed into the open sensor hole, the o-ring 53 providing a seal which prevents debris entering the speed sensor hole during the cleaning port machining operation. The speed sensor securing bolt is then fitted through the hole 51 in the jig base plate (which is aligned with the speed sensor bolt hole in the housing 3) and tightened to secure the jig in position. The jig is thus configured so that there is only one precise position which it may be fitted to the turbocharger housing to thereby ensure that the jig guide 41 is correctly positioned.

Once the jig is in position, the drill bush 45 is first secured within the guide 41 and the cleaning bore is then drilled through the housing using a drill bit 70 of specified diameter which is securely maintained in the required alignment by the drill guide bush 45. The drill preferably includes a stop to ensure that the drill bit does not penetrate any further than is required to machine the cleaning bore, thereby avoiding unintentional damage to the variable geometry actuating mechanism.

Once the cleaning bore has been drilled, the drill bit and drill bit guide bush 45 are removed and the drill bit guide bush is replaced with the tap guide bush. A tap (not shown) is then inserted through the tap guide bush and used to tap the bore previously drilled through the housing wall. The tap and jig are then removed (and the speed sensor refitted). The turbocharger is then ready for a cleaning operation (if required) as described above, following which the cleaning port 30 is sealed with a plug 31 as described above (it will be appreciated that a plug 31 may be fitted immediately after the cleaning port machining operation if no cleaning operation is to be performed).

It will, of course, be appreciated that whereas FIGS. 5a and 5b show the turbine housing removed from the turbocharger, the cleaning port machining operation is designed so that it can be performed on the turbocharger in situ fitted to the engine without the need to remove the turbine housing, or any components of the turbocharger other than as may be required to allow access to the turbocharger for fitting the jig and subsequently drilling/tapping the cleaning bore.

In operation it is preferable to apply a machine shop vacuum to the location of the jig during the drilling and tapping operations to minimise the amount of filings that may enter the turbine through the cleaning bore as it is machined.

It will be appreciated that conventional and readily available drilling and tapping tools may be used.

It will be appreciated that the invention can be applied to other turbocharger housing designs by configuring the jig appropriately. The configuration of the jig can be determined by reference to fixed features of the turbine housing once the desired location of the cleaning port is determined (with reference to the particular variable geometry inlet mechanism to be cleaned).

It will therefore be understood that the application of the present invention is not limited to any particular configuration of turbine housing and, moreover is not limited to any particular design of variable geometry inlet mechanism. For instance, whereas the invention as described above is applied to a turbocharger comprising a variable geometry inlet mechanism including a movable nozzle ring, the invention may equally be applied to other forms of variable geometry inlet mechanism such as swing vane mechanisms as referred to above. It will be appreciated that the preferred location, and angle, of the cleaning port may vary between different turbocharger inlet mechanism configurations.

Other possible modifications to the embodiments of the invention described above, and other applications of the invention, will be readily apparent to the appropriately skilled person.

1. A turbocharger comprising a turbine wheel mounted within a housing for rotation about a turbine axis, a gas flow inlet passage upstream of the turbine wheel, and a gas flow control mechanism located within said housing upstream of said turbine wheel and operable to control gas flow through said gas flow inlet passage, wherein a cleaning port is provided in a wall of the housing, the cleaning port communicating between an external surface of the housing and an internal cavity which communicates with at least one component of the gas flow control mechanism.

2. A turbocharger according to claim 1, wherein the cleaning port is sealed by a removable plug.

3. A turbocharger according to claim 2, wherein the sealing port and plug are screw-threaded.

4. A turbocharger according to claim 1, wherein said gas flow control mechanism comprises a variable geometry mechanism for varying the size of the inlet passage.

5. A turbocharger accordingly to claim 4, wherein said inlet passage is annular and surrounds the turbine wheel, and said variable geometry mechanism includes an annular wall member which is displaceable to vary the width of the annual inlet passage between a first surface defined by the annular wall member and a second surface defined by the housing, wherein the moveable wall member is mounted within said internal cavity.

6. A turbocharger according to claim 5, wherein the annular wall member is displaceable in a direction parallel to the turbine axis.

7. A turbocharger according to claim 5, wherein the moveable wall member is mounted on at least one axially displaceable rod at least a portion of which extends into said cavity.

8. A turbocharger according to claim 1, wherein said cavity is annular.

9. A turbocharger according to claim 1 wherein said cavity is in gas communication with said inlet passage.

10. A turbocharger according to claim 5, wherein the inlet passage communicates with the cavity through at least one aperture defined by the annular wall member.

11. A turbocharger according to claim 4, wherein said inlet passage is an annular passage defined between facing walls of the housing and surrounding the turbine wheel and said variable geometry mechanism includes an annular array of swing vanes mounted within the inlet passage, each vane being mounted for pivoting motion about a respective pivot axis extending across the inlet passage to adjust the effective area of the annular inlet passage.

12. A turbocharger according to claim 11, wherein an annular actuating member is linked to each of the vanes such that rotation of the actuating member about the turbine axis causes pivotal movement of each of the vanes, wherein said annular actuating member is located within said cavity.

13. A turbocharger according to claim 12, wherein said cavity is annular.

14. A turbocharger according to claim 1, wherein said cavity comprises said inlet passage.

15. A turbocharger according to claim 1, wherein the cleaning port extends at an angle α defined between the turbine axis and an orthogonal projection of the cleaning port onto a first reference plane containing the turbine axis and passing through the cleaning port, wherein the angle α is between 0° and 90°.

16. A turbocharger according to claim 15, wherein the angle α is between 30° and 60°.

17. A turbocharger according to claim 15, wherein the cleaning port extends at an angle β defined between the turbine axis and an orthogonal projection of the port onto a second reference plane containing the turbine axis and extending perpendicular to the first reference plane, wherein the angle β is between 0° and 90°.

18. A turbocharger according to claim 17, wherein the angle β is between 15° and 60°.

19. A method of cleaning the gas flow control mechanism of a turbocharger according to claim 1, the method comprising dispensing a volume of cleaning fluid into the cavity via said cleaning port.

20. A method according to claim 19, further comprising actuating the gas flow control mechanism to promote dispersion of the cleaning fluid to components of the gas flow control mechanism.

21. A method according to claim 19, wherein the turbocharger is in situ connected to an internal combustion engine.

22. A method according to claim 21, wherein the engine is run to raise the temperature of the engine and turbocharger to an elevated temperature to enhance operation of the cleaning fluid.

23. A method according to claim 22, comprising:
a. running the engine to raise the temperature of the engine and turbocharger to a normal operating temperature;
b. dispensing cleaning fluid into said cavity when the engine has reached said normal operating temperature;
c. actuating the gas flow control mechanism with the cleaning fluid present in said cavity.

24. A method of machining a cleaning port through a wall of a housing of a turbocharger to produce a turbocharger according to claim 1 the method comprising:
securing a jig to the turbine housing, the jig being adapted for precise location in a predetermined position and orientation on the turbine housing, the jig including a guide bore;
drilling a hole through the housing wall to form said cleaning port by insertion of a drill bit through the guide bore and into contact with the housing wall.

25. A method according to claim 24, further comprising removing the drill bit from said guide bore and inserting a tap through said guide bore and into the cleaning bore to machine a thread on the inner surface of the cleaning bore.

26. A method according to claim 25, wherein the guide bore is adapted to alternately receive and support a drill guide bush adapted for receiving and guiding said drill, and a tap guide bush adapted for receiving and guiding said tap.

27. A jig for use in machining a cleaning port in accordance with the method of claim 24, the jig comprising a base supporting a formation defining said guide bore, the base been configured for securing to the turbocharger housing in a particular predetermined position.

28. A jig according to claim 27, wherein the base supports a plug adapted for location within a predetermined opening defined by the turbine housing to assist in accurate location of the jig.

29. A jig according to claim 27, wherein the base defines an aperture for receiving a securing bolt or the like for securing the jig to the turbine housing.

30. A method of servicing a turbocharger, the turbocharger comprising a turbine wheel mounted within a housing for rotation about a turbine axis, a gas flow inlet passage upstream of said turbine wheel, and a gas flow control mechanism located within said housing upstream of said turbine wheel and operable to control gas flow through said gas flow inlet passage, the method comprising
machining a cleaning port according to the method of claim 24; and
performing a cleaning operation according to the method of claim 19.

31. A method according to claim 30, further comprising sealing the cleaning port with a removable plug after said cleaning operation.
